(19) United States
(12) Patent Application Publication
(10) Pub. No.: US 2016/0249390 A1
(43) Pub. Date: Aug. 25, 2016

(54) MOBILE DEVICE PAGING AND SMALL CELL CONNECTION ESTABLISHMENT IN HETEROGENEOUS NETWORKS

(71) Applicants: Martin Hans, Braunschweig (DE); Maik Bienas, Braunschweig (DE); Michael Faerber, Wolfratshausen (DE); Andreas Schmidt, Braunschweig (DE)

(72) Inventors: Martin Hans, Braunschweig (DE); Maik Bienas, Braunschweig (DE); Michael Faerber, Wolfratshausen (DE); Andreas Schmidt, Braunschweig (DE)

(73) Assignee: INTEL IP CORPORATION, Santa Clara, CA (US)

(21) Appl. No.: 15/026,443

(22) PCT Filed: Dec. 10, 2013
(86) PCT No.: PCT/US2013/074099

§ 371 Date: Mar. 31, 2016

(51) Int. Cl. H04W 76/02; H04W 68/02

(52) U.S. Cl. CPC H04W 76/02; H04W 68/02; H04W 88/02

(57) ABSTRACT

Technology and techniques to page mobile devices and establish connections between mobile devices and small cell base stations in a heterogeneous network (HetNet.) A macro base station pager may transmit an enhanced paging message, the enhanced paging message to include an indication that the paging message may be answered through a small cell base station. A small cell base station configurator may transmit configuration information to the small cell base station. The small cell base station may transmit a beacon and a mobile device may establish a relay connection with the small cell base station to connect the mobile device to the macro base station through the small cell base station based at least in part upon the beacon. Furthermore, a macro base station backhauler may establish a backhaul connection with the small cell base station to communicate signals with the small cell base station related to the relay connection.

### TECHNICAL FIELD

Embodiments described herein generally relate to heterogeneous networks and particularly to paging mobile devices and establishing a connection between a mobile device and a small cell base station in heterogeneous networks.

### BACKGROUND

Modern wireless systems, such as, for example, mobile telecommunication and/or broadband systems may be deployed as heterogeneous networks using multi-radio access technologies to improve spectrum efficiency and data rates. In general, a heterogeneous network (HetNet) is a system of heterogeneous components that may utilize multiple communication technologies, standards, or specifications to communicate.

An example of a HetNet is a mixture of macro base stations (BSs) and small cell BSs providing access to a main network (e.g., mobile broadband network.) The BSs in the HetNet may operate on different frequencies and/or utilize different radio technologies to provide a uniform experience for a user accessing the main network with a mobile device. The macro BSs often provides a large coverage area (e.g., 200 meters to a few kilometers) while the small cell BSs provide smaller coverage areas (e.g., 10 to 200 meters.) The coverage area of a macro BS may be densely populated with multiple small cell BSs (e.g. in order to augment the macro BS coverage area.)

A mobile device connects to the main network through a macro BS. The small cell BSs offer relaying capabilities between the mobile device and the macro BS to provide targeted infill and added capacity to the macro BS's coverage area. Accordingly, during operation, the mobile device may use a small cell BS as a relay between the macro BS. In order to use the small cell BSs as relays, they must be discoverable by the mobile devices. To provide for discovery, each small cell BS transmits a beacon signal and each mobile device listens for beacon signals (or vice versa.) In this manner, the mobile devices may discover the small cell BSs in the HetNet. However, transmitting beacons and listening for beacons is power intensive. As will be appreciated, the small cell BSs and the mobile device may be continually transmitting beacons and/or listening for beacons. Thus, there is a need for improving the energy efficiency with which mobile devices may establish communication with small cell BSs in a HetNet.

### BRIEF DESCRIPTION OF THE DRAWINGS

FIG. 1 illustrates an example of a HetNet according to an embodiment.

FIG. 2 illustrates a paging and connection technique implemented in a HetNet according to an embodiment.

FIG. 3 illustrates an example macro BS according to an embodiment.

FIG. 4 illustrates an example small cell BS according to an embodiment.

FIG. 5 illustrates an example mobile device according to an embodiment.

FIG. 6 illustrates an example of a logic flow for a macro BS according to an embodiment.

FIG. 7 illustrates an example of a logic flow for a small cell BS according to an embodiment.

FIG. 8 illustrates an example of a logic flow for a mobile device according to an embodiment.

FIG. 9 illustrates an example of a logic flow for a mobile device according to an embodiment.

FIG. 10 illustrates an embodiment of a storage medium.

FIG. 11 illustrates a device according to an embodiment.

### DETAILED DESCRIPTION

Examples are generally directed to apparatuses and processes for paging mobile devices in a heterogeneous network (HetNet) and establishing a connection between the mobile device and a small cell base station (BS) in the HetNet. These apparatuses and processes may be included with or implemented by components (e.g., macro BSs, small cell BSs, mobile devices, or the like) of a HetNet in accordance with various wireless network standards.

According to some examples, a HetNet and/or individual components of a HetNet that are configured to page a mobile device and transmit and receive beacon signals between a mobile device and a small cell BS based upon the paging may be provided. For example, a macro BS may transmit an enhanced paging message to a mobile device. A small cell BS may transmit a beacon signal; with the timing of transmitting the beacon signal based upon the transmission of the enhanced paging message. The mobile device may receive the beacon signal; with the timing for receiving the beacon signal based upon the transmission of the enhanced paging message and initiate connection with the small cell BS directly (e.g., may respond to the enhanced paging message by establishing a connection with the small cell BS.) Other examples are provided herein and embodiments are not limited in this context.

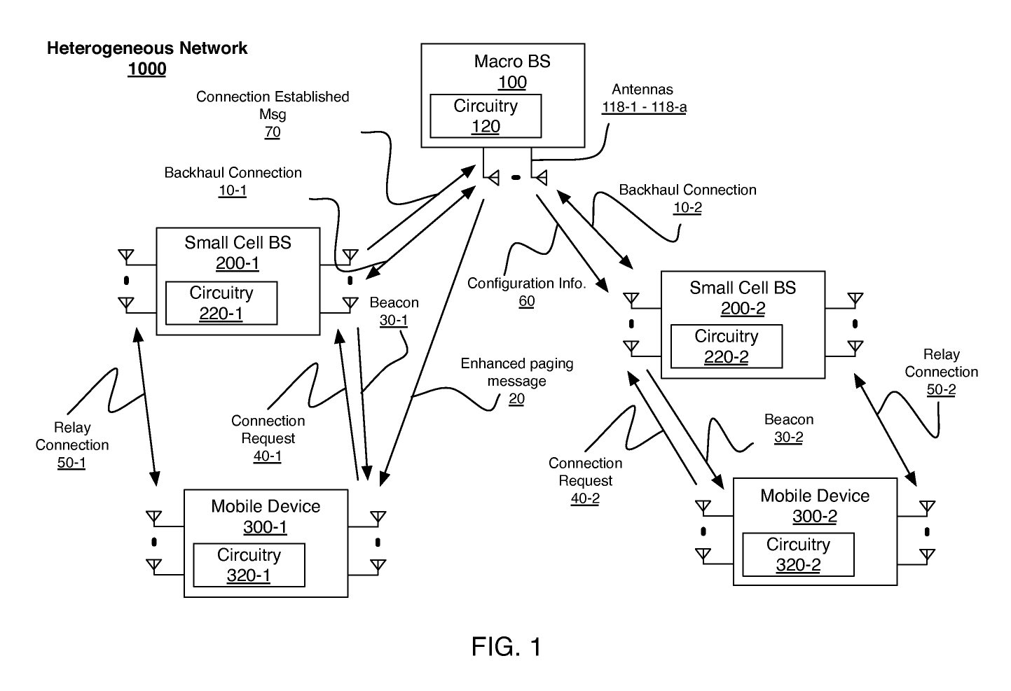

FIG. 1 is a block diagram illustrating an example HetNet 1000. In some examples, as shown in FIG. 1, the HetNet 1000 includes a macro BS 100, small cell BSs 200-1, 200-2 and mobile devices 300-1, 300-2. It is important to note that the number of components in the HetNet 1000 (e.g., the macro BS 100, the small cell BSs 200-1, 200-2, and the mobile devices 300-1, 300-2) is shown at a quantity to facilitate understanding. It is to be appreciated, that the number of components can vary and may, in practice, be much greater than that shown.

In some examples, the macro BS 100, the small cell BSs 200-1, 200-2, and/or the mobile devices 300-1, 300-2 may be components in a wireless communication and/or broadband system, such as, for example, a multi-radio access technology (multi-RAT) system operating in compliance with one or more wireless communication standards. In order to communicate over a radio technology, the macro BS 100, the small cell BSs 200-1 to 200-2, and the mobile devices 300-1 to 300-2 each include one or more antennas. For example, the macro BS 100 is shown including the antenna 110. The small cell BS 200-1 is shown having first antenna 210 and second antenna 212. The small cell BS 200-2 is shown having first antenna 214 and second antenna 216. The mobile device 300-1 is shown having first antenna 310 and second antenna 312. The mobile device 300-2 is shown having first antenna 314 and second antenna 316. It is noted that each of the referenced antennas may correspond to one or more antennas. Said differently, each of the referenced antennas may be an antenna array (e.g., for operating in a multiple input and/or multiple output configuration.) Furthermore, although not depicted in FIG. 1, one or more of the small cell BSs 200-1, 200-2 or one or more of the mobile devices 300-1, 300-2 may only have a single antenna. Embodiments are not limited in this context.

In general, the macro BS 100 may be any of a variety of types of devices configured to provide mobile access to a network (e.g. cellular network, broadband network, or the like.) More particularly, the macro BS 100 provides network access to the mobile devices 300. In some examples, the macro BS 100 provides network access in accordance with any of a variety of different radio access technologies and/or standards. The macro BS 100 includes circuitry 120 to transmit an enhanced paging message 20 to one or more of the mobile devices 300-1, 300-2. For example, this figure depicts the macro BS 100 transmitting the enhanced paging message 20 to the mobile device 300-1. It is to be appreciated, that a variety of techniques for transmitting paging messages are known. In general, the enhanced paging message 20 may be transmitted in accordance with any of these known techniques. However, the enhanced paging message 20 may also include an indication that the paging message may be answered through one of the small cell BSs 200-1, 200-2. Said differently, the mobile device 300-1 may respond to the enhanced paging message 20 by initiating contact with one of the small cell BSs 200-1, 200-2. In addition, the enhanced paging message 20 may include timing information (explained in greater detail below) for purposes of timing the transmission of beacons transmitted by the small cell BSs 200-1, 200-2.

With some examples, the enhanced paging message 20 may include (a) an indication that the macro BS 100 accepts a longer response time to accommodate a response through one of the small cell BSs 200-1, 200-2; (b) an indication that the small cell BSs 200-1, 200-2 are to broadcast a beacon (e.g., the beacons 30-1, 30-2) and support establishing a connection with the mobile device 300-1; (c) an indication of a frequency band in which signals are to be sent by the mobile device 300-1; (d) an indication of a frequency band in which signals from the mobile device 300-1 are to be detected; (e) an indication of a frequency band in which the beacon (e.g., the beacons 30-1, 30-2) is to be transmitted; or (f) an indication of a frequency band in which the beacon (e.g., the beacons 30-1, 30-2) is to be detected.

The macro BS 100 may also include the circuitry 120 to transmit configuration information 60 to the small cell BSs 200-1, 200-2 to cause the small cell BSs 200-1, 200-2 to transmit a beacon (e.g., the beacons 30-1 or 30-2 described in greater detail below.) In some examples, the configuration information 60 may be transmitted wirelessly (e.g., as depicted.) In some examples, the configuration information 60 may be transmitted over a hardwired link (e.g., a non-wireless connection.)

Additionally, the macro BS 100 may also include the circuitry 120 to establish a backhaul connection with one or more of the small cell BSs 200. It is to be appreciated, that techniques for establishing backhaul connections are known. Various embodiments may implement any of these backhaul connection technologies. For example, this figure depicts the backhaul connections 10-1 established with the small cell BS 200-1 and the backhaul connection 10-2 established with the small cell BS 200-2.

With some examples, the macro BS 100 may also include the circuitry 120 to receive a connection established message from one of the small cell BSs indicating that the paged mobile device connected to the small cell BS or initiated a connection establishment to the small cell BS. In response, the macro BS 100 may stop paging the mobile device.

The small cell BSs 200-1, 200-2 may be any of a variety of types of devices configured to extend the coverage area of the macro BS 100, increase the infill capacity of the macro BS 100, and/or provide targeted access (e.g., using mmWave technologies, or the like) within the coverage area of the macro BS 100 in accordance with any of a variety of different radio access technologies and/or standards. The small cell BSs 200-1, 200-2 may sometimes be referred to as micro cells, pico cells, fempto cells, or the like. Each of the small cell BSs 200-1, 200-2 include circuitry 220-1, 220-2. For example, the small cell BSs 200-1 and/or 200-2 may include circuitry (e.g., 220-1 or 220-2) to receive an enhanced paging message intended for a mobile device in the HetNet (e.g., the mobile devices 300-1, 300-2) and transmit a beacon (e.g., the beacon 30-1) with the timing for transmitting the beacon based upon the enhanced paging message. In some examples, the small cell BSs 200-1, 200-2 may include the circuitry 220-1, 220-2 to receive the configuration information 60 from the macro BS 100 and transmit a beacon (e.g., 30-1, 30-2, or the like) based on the configuration information.

With some examples, the small cell BSs 200-1, 200-2 may transmit a beacon a specified amount of time after an enhanced paging message is transmitted by the macro BS 100 or received by the small cell BSs 200-1, 200-2. With some examples, the small cell BSs 200-1, 200-2 may transmit a beacon once, e.g., a selected amount of time after an enhanced paging message is transmitted or as indicated in the configuration information 60. In some examples, the small cell BSs 200-1, 200-2 may transmit a beacon multiple times (e.g., at preselected intervals, the timing of which is based on the enhanced paging message.)

Additionally, the small cell BSs 200-1, 200-2 may include the circuitry 220-1, 220-2 to receive a connection request from a mobile devices (e.g., the connection requests 40-1, 40-2); establish a backhaul connection with the macro BS 100 (e.g., the backhaul connections 10-1, 10-2); and establish a relay connection (e.g., the relay connections 50-1, 50-2) with the mobile devices 300-1, 300-2 to enable the mobile devices 300-1, 300-2 to communicate with the macro BS 100 through the small cell BSs 200-1, 200-2. It is to be appreciated, that a variety of techniques are known for receiving connection requests, establishing backhaul connections, and establishing relay connections. Embodiments described herein may implement any of a variety of these techniques. Examples are not limited in this context.

In some examples, the small cell BSs 200-1, 200-2 may include the circuitry 220-1, 220-2 to transmit a connection established message to the macro BS 100 to cause the macro BS 100 to stop paging the mobile device. For example, this figure depicts the small cell BS 200-1 transmitting a connection established message 70 to the macro BS 100.

The mobile devices 300-1, 300-2 may be any of a variety of devices for accessing services available on the HetNet 1000. For example, the mobile devices 300-1, 300-2 may be a cellular telephone, a smart phone, a tablet computer, a laptop computer, a mobile access point, and/or a mobile hotspot. Additionally, the mobile devices 300-1, 300-2 may also include devices that might not be considered “mobile,” but which are none the less configured to access the HetNet 1000 (e.g., access the network through the macro BS 100.) For example, the mobile devices 300-1, 300-2 may include desktop computers, servers, access points, nodes in the network, or the like. Examples are not limited in the context. Additionally, it is noted, that the mobile device 300-1 and the mobile device 300-2 may be different types of devices (e.g., one may be a smart phone while the other is a tablet computer, or any other possible combination.) Also, it is worth noting that those familiar with HetNets may also refer to the mobile devices 300-1, 300-2 as user devices (UEs.) Examples are not limited in the context.

The mobile devices 300-1, 300-2 include circuitry 320-1, 320-2 to receive an enhanced paging message (e.g., the enhanced paging message 20), receive a beacon (e.g., the beacons 30-1, 30-2,) and establish a relay connection with a small cell BS (e.g., the relay connections 50-1, 50-2). With some examples, the mobile devices 300-1, 300-2 may receive a beacon (e.g., the beacons 30-1, 30-2) with the timing for receiving the beacon based on the enhanced paging message 20. Said differently, the mobile devices 300-1, 300-2 may include the circuitry 320-1, 320-2 to listen for the transmission of a beacon at a specified time interval (or intervals) based upon timing information specified in the enhanced paging message 20 and/or based upon a time in which the enhanced paging message 20 was transmitted.

With some examples, the mobile devices 300-1, 300-2 may receive a beacon based on an enhanced paging message intended for another mobile device in the HetNet 1000. As will be appreciated, in some examples, a mobile device may be idle (also referred to as camped) on a macro BS. For communication initiated from the mobile device (as opposed to being paged by the macro BS as described above) the mobile device would need to initiate contact with the macro BS and then a small cell BS. However, some examples provide that a mobile device may receive a paging message intended for another mobile device, determine the timing information for receiving a beacon from a small cell BS, and initiate contact with a small cell BS to establish a communication pathway with the macro BS through the small cell BS. For example, the mobile device 300-2 may receive the enhanced paging message 20 and based upon timing information for transmitting a beacon signal, receive the beacon 30-2 transmitted from the small cell BS 200-2. After which, the relay connection 50-2 may be established between the mobile device 300-2 and the small cell BS 200-2 to established as described above.

As described above, the enhanced paging message 20 includes an indication that the paging may be answered by initiating contact with a small cell BS. As such, responsive to receiving the enhanced paging message 20, the mobile device 300-1 may initiate contact with one of the small cell BSs (e.g., by transmitting a connection request to the small cell BS.)

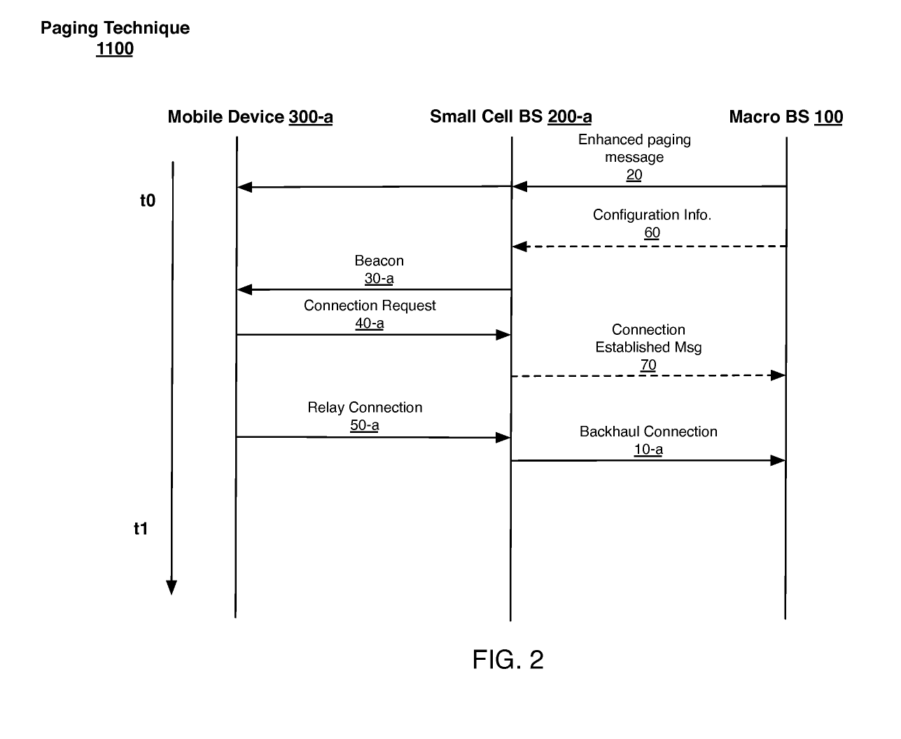

FIG. 2 is a paging and connection technique 1100 that may be implemented by logic and/or features of components in a HetNet. For example, logic and/or features located at or within a macro BS (e.g., the macro BS 100), a small cell BS (e.g., the small cell BSs 200-1, 200-2), and a mobile device (e.g., the mobile devices 300-1, 300-2) may implement the technique 1100. FIG. 2 (and other figures described herein) uses the variable “a” as a designator. As used herein, the variable “a” is intended to be a variable representing any positive integer. Accordingly, as an example, the small cell BS 200-a may correspond to either of the small cell BSs 200-1, 200-2.

The technique 1100 is shown with time interval tO to tl. It is noted that this time scale is shown for illustrative purpose only and is not intended to indicate an actual amount of time between events depicted in the technique 1100 or an actual quantity of time represented. The time scale is shown for purposes of illustration only and any amount of time between events and the quantity of time may be implementation dependent.

The technique 1100 may include transmitting an enhanced paging message from the macro BS 100 to the mobile device 300-a. For example, the enhanced paging message 20 may be transmitted from the macro BS 100 to the mobile device 300-1. As noted above, any of the entities in the HetNet 1000 may receive the enhanced paging message. For example, any combination of the small cell BSs 200-1, 200-2 and/or the mobile device 300-1, 300-2 may receive the enhanced paging message 20. For example, the paging technique 1100 shows bot the mobile device 300-a and the small cell BS 200-a receiving the enhanced paging message 20.

In some examples, the macro BS 100 may additionally transmit configuration information to one or more small cell BSs 200-1, 200-1 in the Het Net 1000. For example, FIG. 1 depicts the macro BS 100 transmitting configuration information 60 to the small cell BS 200-2 (e.g., in order to cause the small cell BS 200-2 to transmit the beacon 30-2.)

The small cell BS 200-a may then transmit a beacon 30-a with the timing for transmitting the beacon based upon either or both of the enhanced paging message 20 or the configuration information 60. Similarly, a mobile device (e.g., the mobile devices 300-1, 300-2) may receive a beacon (e.g., the beacon 30-1, 30-2) with the timing for receiving the beacon based upon the enhanced paging message 20.

The mobile device 300-a may initiate a connection with a small cell BS 200-a based upon receipt of the beacon 30-a. More particularly, the mobile device 300-a may respond to the enhanced paging message 20 by initiating contact with the small cell BS 200-a, which may include transmitting the connection request 40-a to the small cell BS 200-a. Said differently, the receipt of the enhanced paging message 20 may cause the mobile device 300-a to listen for the beacon 30-a in order to establish a connection with the small cell BS 20-a. For example, in FIG. 1, the mobile devices 300-1 and 300-2 are shown transmitting the connection requests 40-1 and 40-2 to the small cell BSs 200-1 and 200-2, respectively. In some examples, the small cell BS 200-a may transmit the connection established message 70 to cause the macro BS 100 to stop paging the mobile device 300-a.

The small cell BS 200-a and the mobile device 300-a may then establish a relay connection 50-a. Additionally, the small cell BS 200-a may establish the backhaul connection 10-a with the macro BS 100. In general, the relay connection 50-a connects the mobile device 300-a to the macro BS 100 through the small cell BS 200-a. The backhaul connection 10-a provides continued exchange of signals with the small cell BS related to the relay connection 50-a.

Accordingly, a technique for paging mobile devices and establishing connections between mobile devices and small cell BSs is described. In particularly, the technique provides for efficiently (e.g., lower power, reduced bandwidth congestion, or the like) paging mobile devices and establishing connections between mobile devices and small cell BSs.

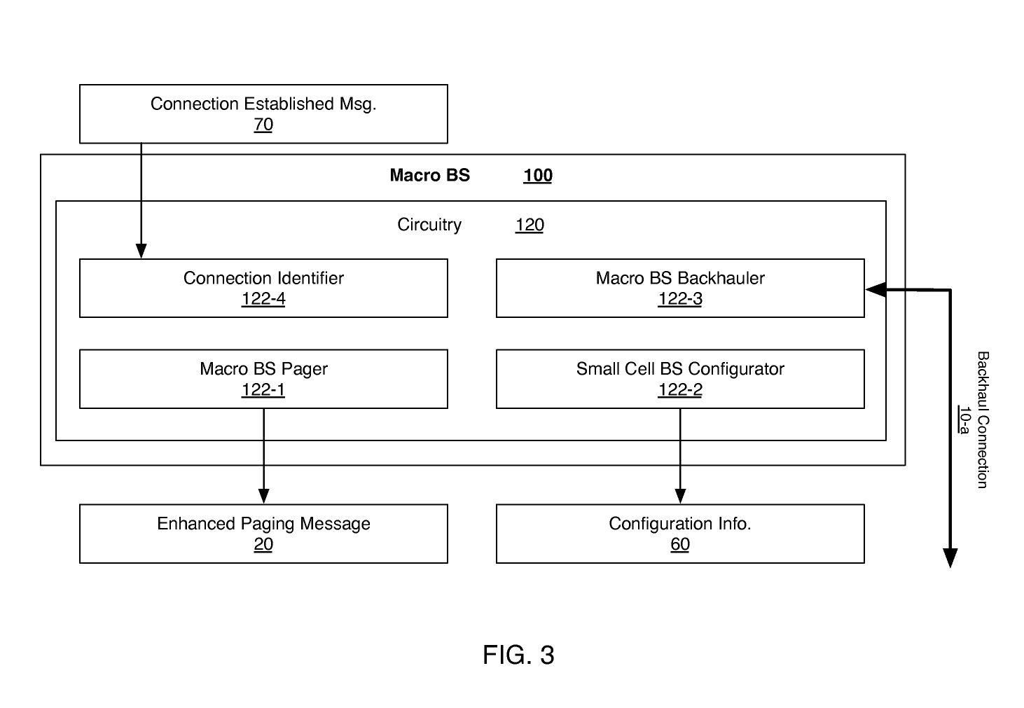

FIGS. 3, 4, and 5 are block diagrams of a macro BS, a small cell BS, and a mobile device, respectively. Although a limited number of elements in a certain topology or configuration, are depicted in these figures, it will be appreciated that more or less elements in alternate configurations may be implemented as desired. The macro BS, the small cell BS, and the mobile device may be implemented as components in a HetNet capable of operating in compliance with one or more radio access technologies and/or standards such as those referenced herein. It is noted, that although the figures are discussed with reference to the HetNet 1000, examples are not limited in this context. In general, each of the figures shows a computer and/or firmware implemented apparatus having circuitry arranged to execute one or more components. The circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as the circuitry. According to some examples circuitry may also be an application specific integrated circuit (ASIC) and the components may be implemented as hardware elements of the ASIC.

Turning more specifically to FIG. 3, the macro BS 100 is depicted including a computer and/or firmware implemented apparatus having circuitry 120 arranged to execute one or more components 122-a.

According to some examples, the macro BS 100 may include a macro base station pager 122-1 for execution by the circuitry 120 to transmit an enhanced paging message, the enhanced paging message including an indication that the paging message may be answered through a small cell BS. For example, the macro BS pager 122-1 may transmit the paging message 20 to the mobile device 300-1.

In some examples, the macro BS 100 may include a small cell BS configurator 122-2 for execution by the circuitry 120 to transmit configuration information to the small BS station, the configuration information to cause the small cell BS to transmit a beacon, a mobile device to establish a relay connection with the small cell BS to connect the mobile device to the macro BS through the small cell BS based at least in part upon the beacon. For example, the small cell BS configurator 122-2 may transmit configuration information 60 to the small cell BS 200-2.

With some examples, the macro BS 100 may include a macro BS backhauler 122-3 for execution by the circuitry 120 to establish a backhaul connection with the small cell BS to provide continued exchange of signals with the small cell BS related to the relay connection. For example, the macro BS backhauler 122-3 may establish the backhaul connection 10-a with the small cell BS 200-a. With some examples, the macro BS backhauler 122-3 may establish context information between the small cell BS 200-a and the macro BS 100, the context information including (i) indications of setup bearers, (ii) indications of mobile stations served by the small cell base station, (iii) indications of a mobile stations served by the small cell base station, (iv) indications of resources of the time, frequency, or power domain to be used by the small cell base station, or (v) indications of minimum or average quality of service provided with the setup bearers.

In some examples, the macro BS 100 may include a connection identifier 122-4 for execution by the circuitry 120 to receive an indication (e.g., the connection established message 70) from the small cell BS 200-a that the mobile device 300-a has established a connection with the small cell BS 200-a or has initiated establishment of such connection. In response, to receiving the indication, the macro BS pager 122-1 may cease transmitting the enhanced paging message 20. With some examples, the connection established message 70 may include an identification corresponding to the mobile device 300-a.

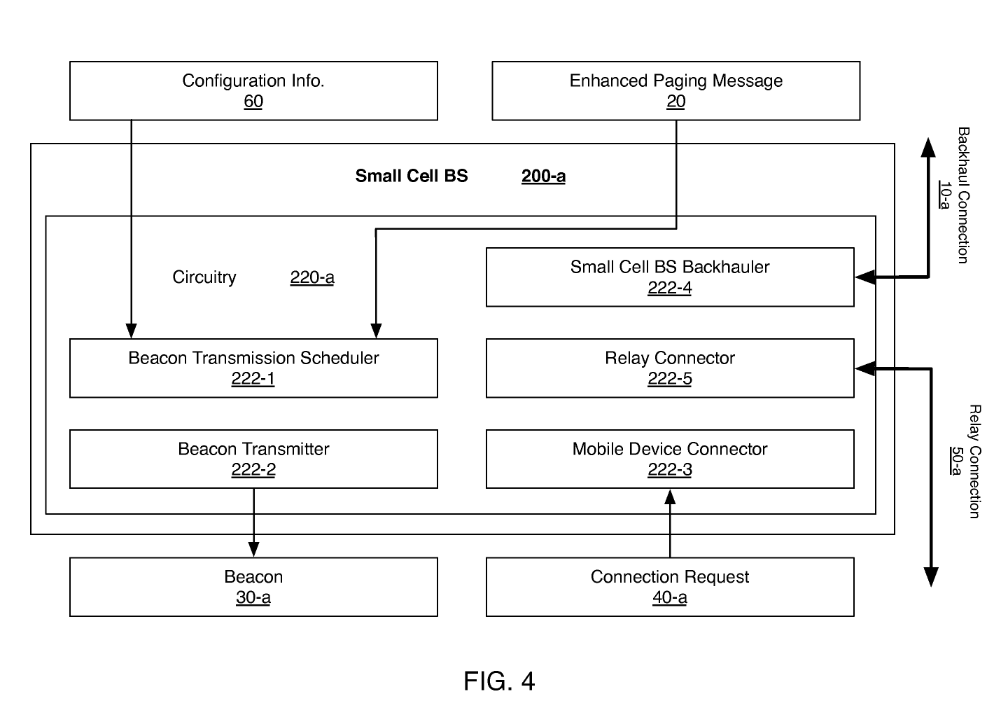

Turning more specifically to FIG. 4, the small cell BS 200-a is depicted including a computer and/or firmware implemented apparatus having circuitry 220-a arranged to execute one or more components 222-a.

According to some examples, the small cell BS 200-a includes a beacon transmission scheduler 222-1 for execution by the circuitry 220-a to receive scheduling information from a macro BS, the scheduling information including indications of timing for transmitting a beacon signal. For example, the beacon transmission scheduler 222-1 may receive indications of scheduling information from either or both an enhanced paging message (e.g., the enhanced paging message 20) or configuration information (e.g., the configuration information 60.)

With some examples, the small cell BS 200-a includes a beacon transmitter 222-2 for execution by the circuitry 220-a to transmit the beacon signal based at least in part on the received scheduling information. For example, the beacon transmitter 222-2 may transmit the beacon 30-a with the timing for transmitting the beacon 30-a based upon the enhanced paging message 20 or the configuration information 60. With some examples, the beacon transmitter 222-2 may transmit the beacon signal on a selected frequency. The selected frequency, may, in some examples, be specified in the enhanced paging message.

In some examples, the small cell BS 200-a includes a mobile device connector 222-3 for execution by the circuitry 220-a to receive a request from the mobile device to establish a connection and to establish the connection with the mobile device. For example, the mobile device connector 222-3 may receive the connection request 40-a from the mobile device 300-a and establish a connection with the mobile device 300-a based upon the connection request 40-a.

With some examples, the small cell BS 200-a includes a small cell backhauler 222-4 for execution by the circuitry 220-a to establish a backhaul connection with the macro BS to provide continued exchange of signal with the macro BS related to the connection with the mobile device. For example, the small cell backhauler 222-4 may establish the backhaul connection 10-a with the macro BS 100.

In some examples, the small cell BS 200-a includes a relay connector 222-5 for execution by the circuitry 220-a to establish a relay connection with the mobile device based at least in part on the received connection request, the relay connection to connect the mobile device to the macro BS through the small cell BS. For example, the relay connector 222-5 may establish the relay connection 50-a with the mobile device 300-a based at least in part on the connection request 40-a. As such, the relay connection provides a connection (e.g., over the relay connection 50-a and the backhaul connection 10-a) between the mobile device 300-a and the macro BS 100.

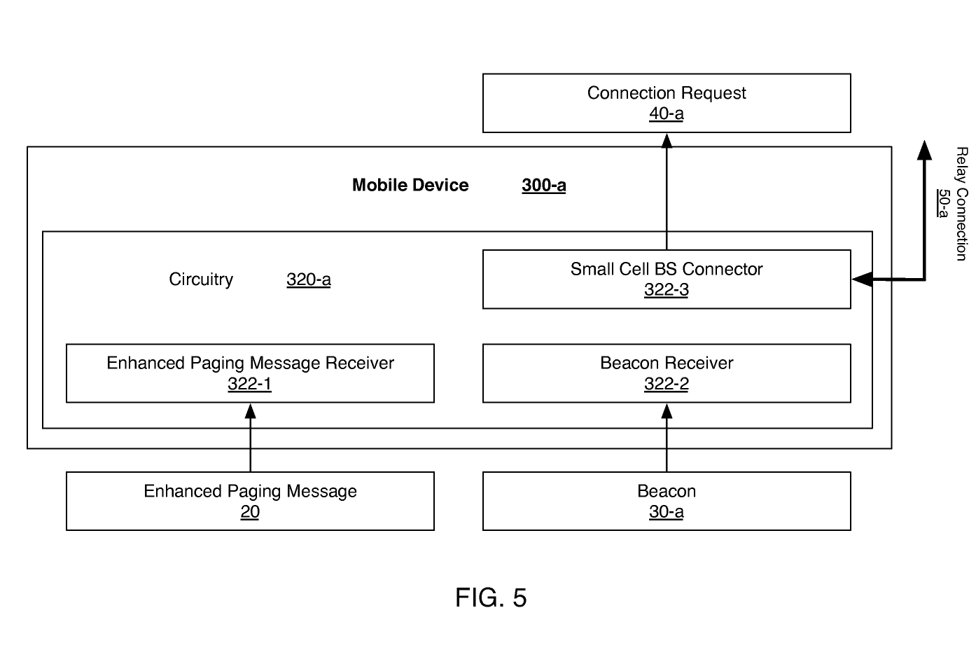

Turning more specifically to FIG. 5, the mobile device 300-a is depicted including a computer and/or firmware implemented apparatus having circuitry 320-a arranged to execute one or more components 322-a.

According to some examples, the mobile device 300-a includes an enhanced paging message receiver 322-1 executable by the circuitry 320-a to receive an enhanced paging message, the enhanced paging message including an indication that the enhanced paging message may be answered through a small cell base station. For example, the enhanced paging message receiver 322-1 may receive the enhanced paging message 20.

With some examples, the mobile device 300-a includes a beacon receiver 322-2 executable by the circuitry 320-a to configure the mobile device 300-a to receive a beacon signal. For example, the beacon receiver 322-2 may configure the mobile device 300-a to listen for and/or receive the beacon 30-a, the timing for listening for and/or receiving the beacon 30-a may be based in part on the enhanced paging message 20. Said differently, the beacon receiver 322-2 may configure the mobile device 300-a to receive the beacon signal based at least in part on the timing of the enhanced paging message 20. In some examples, the enhanced paging message 20 includes an indication of the timing in which the small cell BS 200-a will transmit a beacon 30-a, the beacon receiver 322-2 to configured the mobile device 300-a to receive the beacon 30-a based at least in part on the indication of the timing in which the small cell BS 200-a will transmit the beacon 30-a.

In some examples, the mobile device 300-a includes a small cell BS connector 322-3 executable by the circuitry 320-a to establish a connection with the small cell BS responsive to the reception of the enhanced paging message. For example, the small cell BS connection 322-3 may, based upon receiving the enhanced paging message, transmit the connection request 40-a to the small cell BS 200-a and establish the relay connection 50-a with the small cell BS 200-a. In some examples, the connection request 40-a is transmitted on a random access channel.

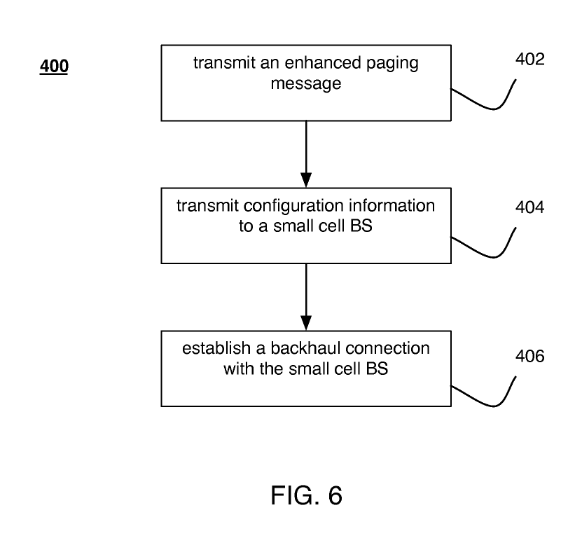

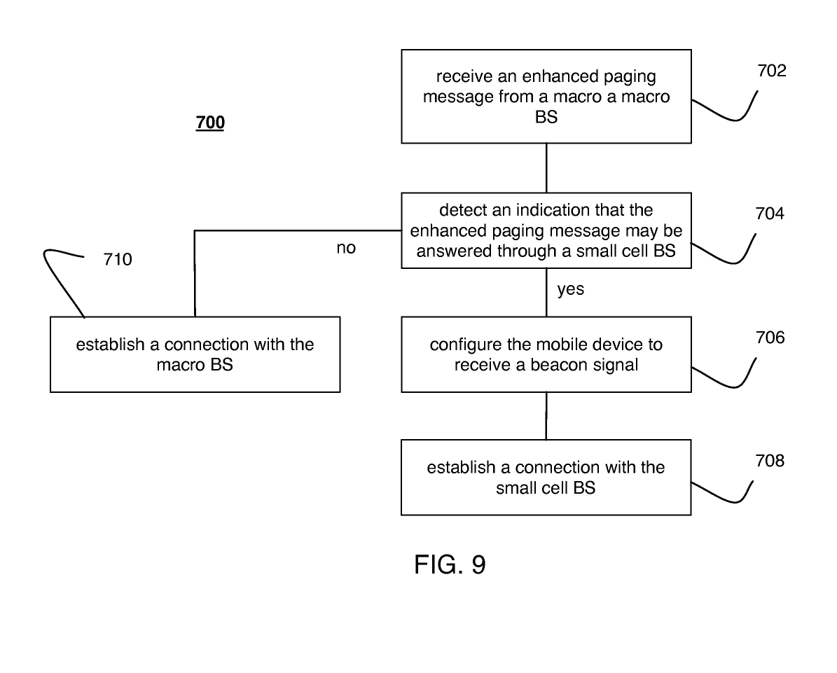

FIGS. 6, 7, 8, and 9 illustrate examples of logic flows 400, 500, 600, and 700, respectively. The logic flows may be representative of some or all of the operations executed by one or more logic, features, or devices described herein. In general, the logic flow 400 may be representative of some or all of the operations executed by logic and/or features of the macro BS 100. In general, the logic flow 500 may be representative of some or all of the operations executed by logic and/or features of the small cell BS 200-a. In general, the logic flows 600 and/or 700 may be representative of some or all of the operations executed by logic and/or features of the mobile device 300-a.

Turning more specifically to FIG. 6, the macro BS pager 122-1, the small cell BS configurator 122-2, and/or the macro BS backhauler 122-3 may implement the logic flow 400.

In the logic flow 400, at block 402, a macro BS in a HetNet may transmit an enhanced paging message to a mobile device, the enhanced paging message including an indication that the paging message may be answered through a small cell base station. For example, the macro BS 100 may transmit the enhanced paging message 20 to the mobile device 300-a. More specifically, the macro BS pager 122-1 may transmit the enhanced paging message 20.

At block 404, the macro BS may transmit configuration information to the small cell BS, the configuration information to cause the small cell BS to transmit a beacon, a mobile device to establish a relay connection with the small cell base station to connect the mobile device to the macro BS through the small cell BS based at least in part upon the beacon. For example, the macro BS 100 may transmit configuration information 60 to the small cell BS 200-a. More specifically, the small cell BS configurator 122-2 may transmit configuration information 60 to the small cell BS 200-a. In some examples, the configuration information may be transmitted in the enhanced paging message 20.

At block 406, the macro BS may establish a backhaul connection with the small cell BS to provide continued exchange of signals with the small cell BS related to the relay connection. For example, the macro BS 100 may establish the backhaul connection 10-a with the small cell BS 200-a to provide continued exchange of signals (or indications of signals) related to the relay connection 50-a.

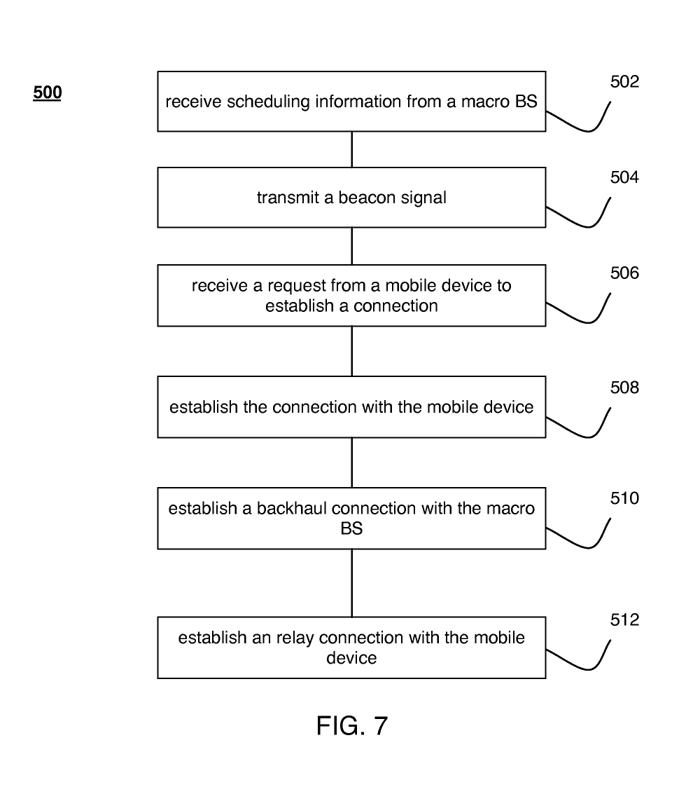

Turning more specifically to FIG. 7, the beacon transmission scheduler 222-1, the beacon transmitter 222-2, the mobile device connector 222-3, the small cell BS backhauler 222-4, and/or the relay connector 222-5 may implement the logic flow 500.

In the logic flow 500, at block 502, a small cell BS in a HetNet may receive scheduling information from a macro BS, the scheduling information including indications of a timing for transmitting of a beacon. For example, the small cell BS 200-a may receive scheduling information (e.g., based on the enhanced paging message 20, based on the configuration information 60, or the like) including indications of a timing for transmitting a beacon. More specifically, the beacon transmission scheduler 222-1 may receive timing information from either or both the enhanced paging message 20 or the configuration information 60.

At block 504, the small cell BS may transmit the beacon based at least in part on the received scheduling information. For example, small cell BS 200-a may transmit the beacon 30-a. More specifically, the beacon transmitter 222-2 may transmit the beacon 30-a.

At block 506, the small cell BS may receive a request from the mobile device to establish a connection. For example, small cell BS 200-a may receive the connection request 40-a from the mobile device 300-a. More specifically, the mobile device connector 222-3 may receive the connection request 40-a.

At block 508, the small cell BS may establish the connection with the mobile device. For example, the small cell BS 200-a may establish a connection with the mobile device 300-a.

At block 510, the small cell BS may establish a backhaul connection with the macro BS to provide continued exchange of signal with the macro BS related to the connection with the mobile device. For example, the small cell BS may establish the backhaul connection 10-a with the macro BS 100. More specifically, the small cell BS backhauler 222-4 may establish the backhaul connection 10-a.

At block 512, the small cell BS may establish a relay connection with the mobile device based at least in part on the received connection request, the relay connection to connect the mobile device to the macro BS through the small cell base station. For example, the small cell BS 200-a may establish the relay connection 50-a with the mobile device 300-a. More specifically, the relay connector 222-5 may establish the relay connection 50-a.

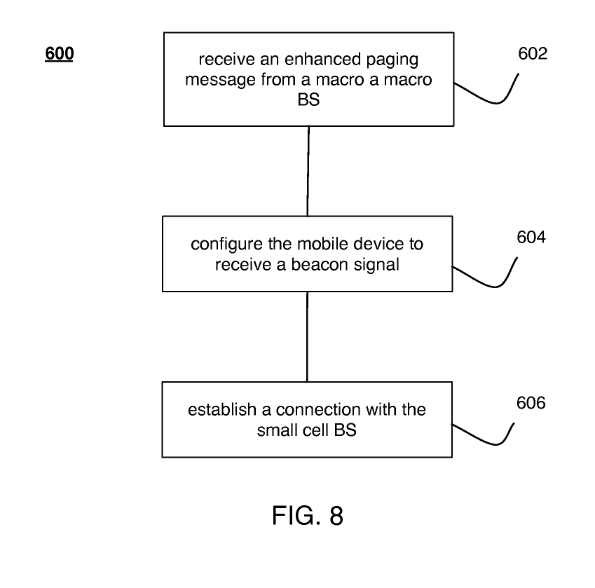

Turning more specifically to FIG. 8, the enhanced paging message receiver 322-1, the beacon receiver 322-2, and/or the small cell BS connector 322-3 may implement the logic flow 600.

In the logic flow 600, at block 602, a mobile device in a HetNet may receive an enhanced paging message, the enhanced paging message including an indication that the enhanced paging message may be answered through a small cell BS. For example, the mobile device 300-a may receive the enhanced paging message 20. More specifically, the enhanced paging message receiver 322-1 may receive the enhanced paging message 20.

At block 604, the mobile device may be configured to receive a beacon. For example, the mobile device 300-a may be configured to receive a beacon with the timing for receiving the beacon based on the enhanced paging message 20. More specifically, the beacon receiver 322-2 may configure the mobile device 300-a to receive the beacon 30-a.

At block 606, the mobile device may, responsive to receiving the enhanced paging message, establish a connection with the small cell BS. For example, the mobile device 300-a may transmit a connection request to the small cell BS and establish a relay connection with the small cell BS. More specifically, the small cell BS connector 322-3 may transmit the connection request 40-a to the small cell BS 200-a and establish the relay connection 50-a with the small cell BS 200-a.

Turning more specifically to FIG. 8, the enhanced paging message receiver 322-1, the beacon receiver 322-2, and/or the small cell BS connector 322-3 may implement the logic flow 700.

In the logic flow 700, at block 702, a mobile device in a HetNet may receive an enhanced paging message. For example, the mobile device 300-a may receive the enhanced paging message 20. More specifically, the enhanced paging message receiver 322-1 may receive the enhanced paging message 20.

At block 704 it is detected whether the received enhanced paging message includes an indication that the enhanced paging message may be answered through a small cell BS.

If it is detected at block 704 that the received enhanced paging message includes an indication that the enhanced paging message may be answered through a small cell BS, the logic flow continues at block 706. Otherwise, the logic flow continues at block 710.

At block 706, the mobile device may be configured to receive a beacon. For example, the mobile device 300-a may be configured to receive a beacon with the timing for receiving the beacon based on the enhanced paging message 20. More specifically, the beacon receiver 322-2 may configure the mobile device 300-a to receive the beacon 30-a.

At block 708, the mobile device may, responsive to receiving the enhanced paging message, establish a connection with the small cell BS. For example, the mobile device 300-a may transmit a connection request to the small cell BS and establish a relay connection with the small cell BS. More specifically, the small cell BS connector 322-3 may transmit the connection request 40-a to the small cell BS 200-a and establish the relay connection 50-a with the small cell BS 200-a.

At block 710, the mobile device may, responsive to receiving the enhanced paging message, establish a connection with the macro BS. For example, the mobile device 300-a may transmit a connection request to the macro BS and establish a connection with the macro BS.

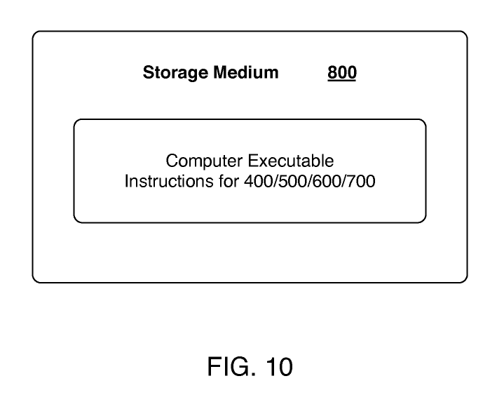

FIG. 10 illustrates an embodiment of a storage medium 800. The storage medium 800 may comprise an article of manufacture. In some examples, the storage medium 800 may include any non-transitory computer readable medium or machine readable medium, such as an optical, magnetic or semiconductor storage. The storage medium 800 may store various types of computer executable instructions. For example, the storage medium 800 may store various types of computer executable instructions to implement logic flow 400. In some examples, the storage medium 800 may store various types of computer executable instructions to implement logic flow 500. With some examples, the storage medium 800 may store various types of computer executable instructions to implement logic flow 600. With some examples, the storage medium 800 may store various types of computer executable instructions to implement logic flow 700.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

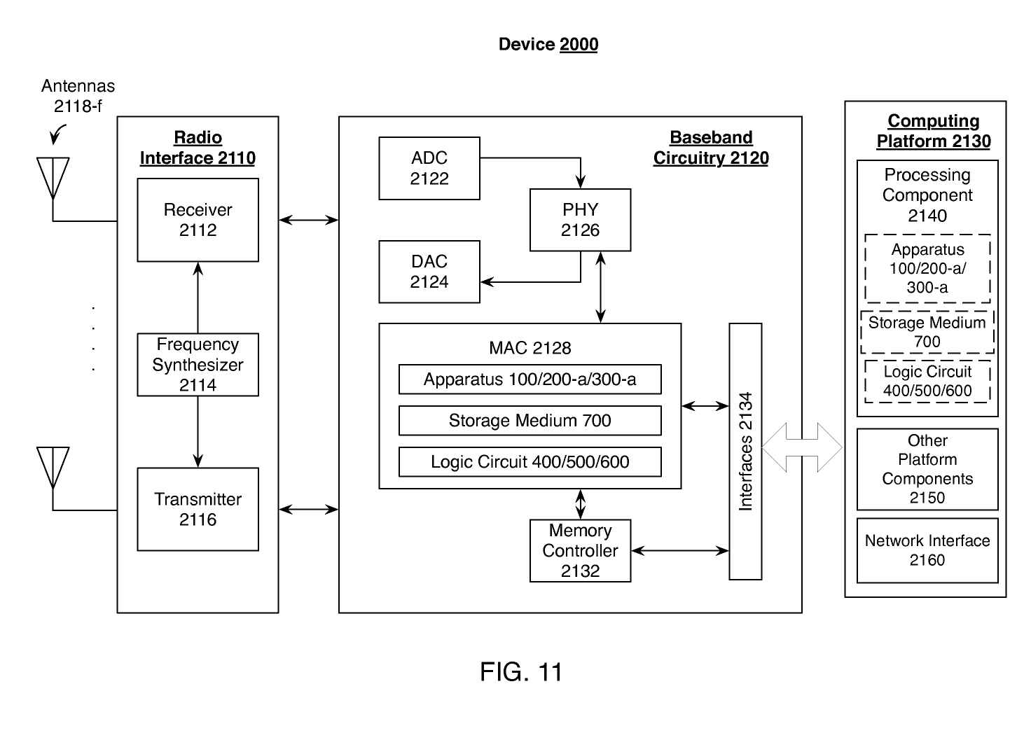

FIG. 11 illustrates an embodiment of a device 2000. In some examples, device 2000 may be configured or arranged for multi-RAT communications in a HetNet such as the HetNet 1000 shown in FIG. 1. In some examples, the macro BS 100 may be implemented in the device 2000. For example, the device 2000 may implement the macro BS as apparatus 100. With some examples, the small cell BS 200-a may be implemented in the device 2000. For example, the device 2000 may implement the small cell BS as apparatus 200-a. In some examples, the mobile device 300-a may be implemented in the device 2000. For example, the device 2000 may implement the mobile device as apparatus 300-a. Additionally, the device 2000 may implement storage medium 800 and/or a logic circuit 400/500/600/700. The logic circuits may include physical circuits to perform operations described for the apparatus 100, 200-a, 300-a, storage medium 800, logic flow 400, logic flow 500, logic flow 600, and/or logic flow 700. As shown in FIG. 10, device 2000 may include a radio interface 2110, baseband circuitry 2120, and computing platform 2130, although examples are not limited to this configuration.

The device 2000 may implement some or all of the structure and/or operations for the apparatus 100/200-a/d300-a, the storage medium 700 and/or the logic circuit 400/500/600 in a single computing entity, such as entirely within a single device. The embodiments are not limited in this context.

Radio interface 2110 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 2110 may include, for example, a receiver 2112, a transmitter 2116 and/or a frequency synthesizer 2114. Radio interface 2110 may include bias controls, a crystal oscillator and antennas 2118-1 to 2118-f. In another embodiment, radio interface 2110 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 2120 may communicate with radio interface 2110 to process receive and/or transmit signals and may include, for example, an analog-to-digital converter 2122 for down converting received signals, a digital-to-analog converter 2124 for up converting signals for transmission. Further, baseband circuitry 2120 may include a baseband or physical layer (PHY) processing circuit 2126 for PHY link layer processing of respective receive/transmit signals. Baseband circuitry 2120 may include, for example, a processing circuit 2128 for medium access control (MAC)/data link layer processing. Baseband circuitry 2120 may include a memory controller 2132 for communicating with MAC processing circuit 2128 and/or a computing platform 2130, for example, via one or more interfaces 2134.

In some embodiments, PHY processing circuit 2126 may include a frame construction and/or detection module, in combination with additional circuitry such as a buffer memory, to construct and/or deconstruct communication frames (e.g., containing subframes). Alternatively or in addition, MAC processing circuit 2128 may share processing for certain of these functions or perform these processes independent of PHY processing circuit 2126. In some embodiments, MAC and PHY processing may be integrated into a single circuit.

Computing platform 2130 may provide computing functionality for device 2000. As shown, computing platform 2130 may include a processing component 2140. In addition to, or alternatively of, baseband circuitry 2120 of device 2000 may execute processing operations or logic for the apparatus 100/200-a/300-a, storage medium 800, and logic circuit 400/500/600/700 using the processing component 2130. Processing component 2140 (and/or PHY 2126 and/or MAC 2128) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 2130 may further include other platform components 2150. Other platform components 2150 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 2130 may further include a network interface 2160. In some examples, network interface 2160 may include logic and/or features to support network interfaces operated in compliance with one or more wireless broadband technologies such as those described in one or more standards associated with IEEE 802.11 such as IEEE 802.11u or with technical specification such as WFA Hotspot 2.0.

Device 2000 may be part of a source or destination node in a MIMO system and may be included in various types of computing devices to include, but not limited to, user equipment, a computer, a personal computer (PC), a desktop computer, a laptop computer, a notebook computer, a netbook computer, a tablet computer, an ultra-book computer, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 2000 described herein; may be included or omitted in various embodiments of device 2000, as suitably desired. In some embodiments, device 2000 may be configured to be compatible with protocols and frequencies associated with IEEE 802.11 Standards or Specification and/or 3GPP Standards or Specifications for MIMO systems, although the examples are not limited in this respect.

The components and features of device 2000 may be implemented using any combination of discrete circuitry, application specific integrated circuits (ASICs), logic gates and/or single chip architectures. Further, the features of device 2000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 2000 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

### Example 1

An apparatus for a macro base station in a heterogeneous network. The apparatus including circuitry, a macro base station pager for execution by the circuitry to transmit an enhanced paging message, the enhanced paging message to include an indication that the paging message may be answered through a small cell base station, a small cell base station configurator for execution by the circuitry to transmit configuration information to the small cell base station, the configuration information to cause the small cell base station to transmit a beacon to establish a relay connection with a mobile device and a macro base station backhauler for execution by the circuitry to establish a backhaul connection with the small cell base station to communicate signals with the small cell base station related to the relay connection.

### Example 2

The apparatus of example 1, wherein the enhanced paging message is intended for the mobile device, the apparatus further comprising a paging response receiver for execution by the circuitry to receive the mobile device's response to the enhanced paging message from the small cell base station.

### Example 3

The apparatus of example 2, further comprising a connection identifier for execution by the circuitry to receive an indication from the small cell base station that the mobile device has established a connection with the small cell base station, the macro base station pager to cease transmitting the enhanced paging message based at least in part on the received indication that the mobile device has established a connection with the small cell base station.

### Example 4

The apparatus of example 3, wherein the received indication includes an identification corresponding to the mobile device.

### Example 5

The apparatus of any one of examples 3 to 4, wherein the connection between the mobile device and the small cell base station is a mmWave connection.

### Example 6

The apparatus of example 1, wherein the enhanced paging message is intended for the small cell base station, the enhanced paging message to include an indication that the small cell base station is to transmit a beacon with the transmission time for transmitting the beacon based at least in part on the enhanced paging message.

### Example 7

The apparatus of any one of examples 1 to 6, the macro base station backhauler to establish context information between the small cell base station and the macro base station, the context information to include one or more indications selected from the group consisting of (i) indications of setup bearers, (ii) indications of mobile stations served by the small cell base station, (iii) indications of a mobile stations served by the small cell base station, (iv) indications of resources of the time, frequency, or power domain to be used by the small cell base station, or (v) indications of minimum or average quality of service provided with the setup bearers.

### Example 8

The apparatus of any one of examples 1 to 7, the enhanced paging message to include at least one of the following: (a) an indication that the macro base station accepts a longer response time to accommodate a response through the small cell base station; (b) an indication that the small cell base station is to broadcast a beacon and support establishing a connection with the mobile device; (c) an indication of a frequency band in which signals from the mobile device are to be detected; or (d) an indication of a frequency band in which the beacon signal is to be transmitted.

### Example 9

The apparatus of any one of examples 1 to 7, further comprising an antenna, the small cell base station configurator operative on the antenna to transmit the configuration information to the small cell base station using the antenna.

### Example 10

The apparatus of any one of examples 1 to 7, further comprising an anntenna, the macro base station backhauler operative on the antenna to establish the backhaul connection with the small cell base station using the antenna.

### Example 11

The apparatus of any one of examples 9 to 10, the antenna to transmit and receive signals on a mmWave frequency band.

### Example 12

The apparatus of any one of examples 1 to 7, wherein the macro base station is communicatively coupled to the small cell base station using a hardwired link, the small cell base station configurator operative on the hardwired link to transmit the configuration information to the small cell base station using the hardwired link.

### Example 13

An apparatus for a small cell base station in a heterogeneous network. The apparatus including circuitry, a beacon transmission scheduler for execution by the circuitry to receive scheduling information from a macro base station, the scheduling information to include indications of timing for transmitting a beacon signal, a beacon transmitter for execution by the circuitry to transmit the beacon signal based at least in part on the received scheduling information, a mobile device connector for execution by the circuitry to receive a request from the mobile device to establish a connection and to establish the connection with the mobile device, a small cell backhauler for execution by the circuitry to establish a backhaul connection with the macro base station to communicate signals with the macro base station related to the connection with the mobile device, and a radio relay connector for execution by the circuitry to establish a relay connection with the mobile device based at least in part on the received connection request, the relay connection to connect the mobile device to the macro base station through the small cell base station.

### Example 14

The apparatus of example 13, the scheduling information to include indications that the schedule for transmission of the beacon signal is based at least in part on the time of transmission of an enhanced paging message.

### Example 15

The apparatus of any one of examples 13 to 14, the scheduling information to include an identification corresponding to the small cell base station.

### Example 16

The apparatus of any one of examples 13 to 15, the beacon transmission scheduler to derive the scheduling information from an enhanced paging message transmitted from the macro base station.

### Example 17

The apparatus of example 16, wherein the enhanced paging message is transmitted to the mobile device.

### Example 18

The apparatus of any one of examples 13 to 17, the beacon transmitter to transmit the beacon signal on a selected frequency.

### Example 19

The apparatus of example 18, wherein the selected frequency is specified in the enhanced paging message.

### Example 20

The apparatus of any one of examples 13 to 19, further comprising a mmWave beam-forming antenna, the mobile device connector operable on the mmWave beam-forming antenna to establish the connection with the mobile device using a mmWave beam forming connection.

### Example 21

The apparatus of any one of examples 13 to 20, wherein the request from the mobile device to establish a connection is sent on a random access channel.

### Example 22

The apparatus of any one of examples 13 to 21, further comprising a mobile device connection reporter for execution by the circuitry to transmit an indication to the macro base station that a connection establishment request has been received from the mobile device, the indication to include an identification corresponding to the mobile device.

### Example 23

An apparatus for a mobile device in a heterogeneous network. The apparatus including circuitry, an enhanced paging message receiver executable by the circuitry to receive an enhanced paging message, the enhanced paging message to include an indication that the enhanced paging message may be answered through a small cell base station, a beacon receiver executable by the circuitry to configure the mobile device to receive a beacon signal, and a small cell base station connector executable by the circuitry to establish a connection with the small cell base station responsive to the reception of the enhanced paging message.

### Example 24

The apparatus of example 23, the beacon receiver to configure the mobile device to receive the beacon signal based at least in part on the timing of the enhanced paging message.

### Example 25

The apparatus of example 23, wherein the enhanced paging message includes an indication of the timing in which the small cell base station will transmit a beacon signal, the beacon receiver to configured the mobile device to receive the beacon signal is based at least in part on the indication of the timing in which the small cell base station will transmit a beacon signal.

### Example 26

The apparatus of any one of examples 23 to 25, wherein the enhanced paging message includes an indication of the frequency in which the beacon signal will be transmitted, the beacon receiver to configure the mobile device to receive the beacon signal using the indicated frequency.

### Example 27

The apparatus of any one of examples 23 to 26, wherein the mobile device is a first mobile device and wherein the enhanced paging message is intended for either or both of a second mobile device and the small cell base station.

### Example 28

The apparatus of any one of examples 23 to 27, the small cell base station connector to transmit a request to establish a connection to the small cell base station.

### Example 29

The apparatus of example 28, wherein the request is sent on a random access channel.

### Example 30

The apparatus of any one of examples 23 to 29, wherein the connection with the small cell base station is a mmWave beam-forming connection.

### Example 31

The apparatus of any one of examples 23 to 30, further comprising an enhanced paging message responder executable by the circuitry to transmit a response to the enhanced paging message to the macro base station using a relay connection, the relay connection connecting the mobile device to the macro base station through the small cell base station.

### Example 32

A method implemented by a macro base station in a heterogeneous network. The method including transmitting an enhanced paging message, the enhanced paging message to include an indication that the paging message may be answered through a small cell base station, transmitting configuration information to the small cell base station, the configuration information to cause the small cell base station to transmit a beacon to establish a relay connection with a mobile device, and establishing a backhaul connection with the small cell base station to communicate signals with the small cell base station related to the relay connection.

### Example 33

The method of example 32, wherein the enhanced paging message is intended for the mobile device, the method further comprising receiving the mobile devices response to the enhanced paging message from the small cell base station.

### Example 34

The method of any one of examples 32 to 33, further including: receiving an indication from the small cell base station that the mobile device has established a connection with the small cell base station, and ceasing transmitting the enhanced paging message based at least in part on the received indication that the mobile device has established a connection with the small cell base station.

### Example 35

The method of example 34, wherein the received indication includes an identification corresponding to the mobile device.

### Example 36

The method of any one of examples 32 to 35, wherein the connection between the mobile device and the small cell base station is a mmWave connection.

### Example 37

The method of any one of examples 32 to 36, wherein the enhanced paging message is intended for the small cell base station, the enhanced paging message to include an indication that the small cell base station is to transmit a beacon with the transmission time for transmitting the beacon based at least in part on the enhanced paging message.

### Example 38

The method of any one of examples 32 to 37, the enhanced paging message to include at least one of the following: (a) an indication that the macro base station accepts a longer response time to accommodate a response through the small cell base station; (b) an indication that the small cell base station is to broadcast a beacon and support establishing a connection with the mobile device; (c) an indication of a frequency band in which signals from the mobile device are to be detected; or (d) an indication of a frequency band in which the beacon signal is to be transmitted.

### Example 39

The method of any one of examples 32 to 38, wherein the configuration information is transmitted to the small cell base station using an antenna.

### Example 40

The method of any one of examples 32 to 39, wherein the backhaul connection with the small cell base station is established using an antenna.

### Example 41

The method of example 40, wherein the backhaul connection with the small cell base station is on a mmWave frequency band.

### Example 42

The method of any one of examples 32 to 39, wherein the configuration information is transmitted to the small cell base station using a hardwired link.

### Example 43

A method implemented by a small cell base station in a heterogeneous network. the method including receiving scheduling information from a macro base station, the scheduling information to include indications of a timing for transmitting of a beacon signal, transmitting the beacon signal based at least in part on the received scheduling information, receiving a request from the mobile device to establish a connection, establishing the connection with the mobile device, establishing a backhaul connection with the macro base station to communicate signals with the macro base station related to the connection with the mobile device, and establishing a relay connection with the mobile device based at least in part on the received connection request, the relay connection to connect the mobile device to the macro base station through the small cell base station.

### Example 44

The method of example 43, the schedule for transmission of the beacon signal based at least in part on the time of transmission of an enhanced paging message.

### Example 45

The method of any one of examples 43 to 44, the scheduling information to include an identification corresponding to the small cell base station.

### Example 46

The method of any one of examples 43 to 45, further comprising deriving the scheduling information from an enhanced paging message transmitted from the macro base station.

### Example 47

The method of example 46, wherein the enhanced paging message is transmitted to the mobile device.

### Example 48

The method of any one of examples 43 to 47, further comprising transmitting the beacon signal on a selected frequency.

### Example 49

The method of example 48, wherein the selected frequency is specified in the enhanced paging message.

### Example 50

The method of any one of examples 43 to 49, wherein the connection with the mobile device is established using a mmWave beam forming antenna.

### Example 51

The method of any one of examples 43 to 50, wherein the request from the mobile device to establish a connection is sent on a random access channel.

### Example 52

The method of any one of examples 43 to 51, further comprising transmitting an indication to the macro base station that a connection establishment request has been received from the mobile device, the indication to include an identification corresponding to the mobile device.

### Example 53

A method implemented in a mobile device in a heterogeneous network. The method including receiving an enhanced paging message, the enhanced paging message to include an indication that the enhanced paging message may be answered through a small cell base station, configuring the mobile device to receive a beacon signal, and responsive to receiving enhanced paging message, establishing a connection with the small cell base station.

### Example 54

The method of example 53, wherein configuring the mobile device to receive the beacon signal is based at least in part on the timing of the enhanced paging message.

### Example 55

The method of example 53, wherein the enhanced paging message includes an indication of the timing in which the small cell base station will transmit the beacon signal and wherein configuring the mobile device to receive the beacon signal is based at least in part on the indication of the timing in which the small cell base station will transmit the beacon signal.

### Example 56

The method of any one of examples 53 to 55, wherein the enhanced paging message includes an indication of the frequency in which the beacon signal will be transmitted, the method further comprising receiving the beacon signal using the indicated frequency.

### Example 57

The method of any one of examples 53 to 56, wherein the mobile device is a first mobile device and wherein the enhanced paging message is intended for either or both of a second mobile device and the small cell base station.

### Example 58

The method of any one of examples 53 to 57, further comprising transmitting a request to establish a connection to the small cell base station.

### Example 59

The method of example 58, wherein the request is sent on a random access channel.

### Example 60

The method of any one of examples 53 to 59, wherein the connection with the small cell base station is a mmWave beam-forming connection.

### Example 61

The method of any one of examples 53 to 60, further comprising transmitting a response to the enhanced paging message to the macro base station using a relay connection, the relay connection connecting the mobile device to the macro base station through the small cell base station.

### Example 62

An apparatus comprising means to perform the method of any one of examples 32 to 61.

### Example 63

At least one machine readable medium comprising a plurality of instructions that in response to being executed on a macro base station, a small cell base station, or a mobile device in a heterogeneous network cause either the macro base station, the small cell base station, or the mobile device to perform the method of any of examples 32 to 61.

1. An apparatus for a macro base station in a heterogeneous network comprising:
circuitry;
a macro base station pager for execution by the circuitry to transmit an enhanced paging message, the enhanced paging message to include an indication that the paging message may be answered through a small cell base station;
a small cell base station configurator for execution by the circuitry to transmit configuration information to the small cell base station, the configuration information to cause the small cell base station to transmit a beacon to establish a relay connection with a mobile device; and
a macro base station backhauler for execution by the circuitry to establish a backhaul connection with the small cell base station to communicate signals with the small cell base station related to the relay connection.

2. The apparatus of claim 1, wherein the enhanced paging message is intended for the mobile device, the apparatus further comprising a paging response receiver for execution by the circuitry to receive the mobile device's response to the enhanced paging message from the small cell base station.

3. The apparatus of claim 2, further comprising a connection identifier for execution by the circuitry to receive an indication from the small cell base station that the mobile device has established a connection with the small cell base station, the macro base station pager to cease transmitting the enhanced paging message based at least in part on the received indication that the mobile device has established a connection with the small cell base station.

4. The apparatus of claim 1, the macro base station backhauler to establish context information between the small cell base station and the macro base station, the context information including one or more indications selected from the group consisting of (i) indications of setup bearers, (ii) indications of mobile stations served by the small cell base station, (iii) indications of a mobile stations served by the small cell base station, (iv) indications of resources of the time, frequency, or power domain to be used by the small cell base station, or (v) indications of minimum or average quality of service provided with the setup bearers.

5. The apparatus of claim 1, the enhanced paging message including at least one of the following:
(a) an indication that the macro base station accepts a longer response time to accommodate a response through the small cell base station;
(b) an indication that the small cell base station is to broadcast a beacon and support establishing a connection with the mobile device;
(c) an indication of a frequency band in which signals from the mobile device are to be detected; or
(d) an indication of a frequency band in which the beacon signal is to be transmitted.

6. The apparatus of claim 1, wherein the macro base station is communicatively coupled to the small cell base station using a hardwired link, the small cell base station configurator operative on the hardwired link to transmit the configuration information to the small cell base station using the hardwired link.

7. An apparatus for a small cell base station in a heterogeneous network comprising:
circuitry;
a beacon transmission scheduler for execution by the circuitry to receive scheduling information from a macro base station, the scheduling information to include indications of timing for transmitting a beacon signal;
a beacon transmitter for execution by the circuitry to transmit the beacon signal based at least in part on the received scheduling information;
a mobile device connector for execution by the circuitry to receive a request from the mobile device to establish a connection and to establish the connection with the mobile device;
a small cell backhauler for execution by the circuitry to establish a backhaul connection with the macro base station to communicate signals with the macro base station related to the connection with the mobile device; and
a radio relay connector for execution by the circuitry to establish a relay connection with the mobile device based at least in part on the received connection request, the relay connection to connect the mobile device to the macro base station through the small cell base station.

8. The apparatus of claim 7, the scheduling information including indications that the schedule for transmission of the beacon signal is based at least in part on the time of transmission of an enhanced paging message.

9. The apparatus of claim 7, further comprising a mmWave beam-forming antenna, the mobile device connector operable on the mmWave beam-forming antenna to establish the connection with the mobile device using a mmWave beam forming connection.

10. The apparatus of claim 7, further comprising a mobile device connection reporter for execution by the circuitry to transmit an indication to the macro base station that a connection establishment request has been received from the mobile device, the indication including an identification corresponding to the mobile device.

11. The apparatus of claim 7, the beacon transmitter to transmit the beacon signal on a selected frequency, the selected frequency is specified in the enhanced paging message.

12. A method implemented by a small cell base station in a heterogeneous network comprising:
receiving scheduling information from a macro base station, the scheduling information including indications of a timing for transmitting of a beacon signal;
transmitting the beacon signal based at least in part on the received scheduling information;
receiving a request from the mobile device to establish a connection;
establishing the connection with the mobile device;
establishing a backhaul connection with the macro base station to communicate signals with the macro base station related to the connection with the mobile device; and
establishing a relay connection with the mobile device based at least in part on the received connection request, the relay connection to connect the mobile device to the macro base station through the small cell base station.

13. The method of claim 12, the schedule for transmission of the beacon signal based at least in part on the time of transmission of an enhanced paging message.

14. The method of claim 12, further comprising transmitting an indication to the macro base station that a connection establishment request has been received from the mobile device, the indication including an identification corresponding to the mobile device.

15. An apparatus for a mobile device in a heterogeneous network comprising:
circuitry;
an enhanced paging message receiver executable by the circuitry to receive an enhanced paging message, the enhanced paging message to include an indication that the enhanced paging message may be answered through a small cell base station;
a beacon receiver executable by the circuitry to configure the mobile device to receive a beacon signal; and
a small cell base station connector executable by the circuitry to establish a connection with the small cell base station responsive to the reception of the enhanced paging message.

16. The apparatus of claim 15, the beacon receiver to configure the mobile device to receive the beacon signal based at least in part on the timing of the enhanced paging message.

17. The apparatus of claim 16, wherein the enhanced paging message includes an indication of the timing in which the small cell base station will transmit a beacon signal, the beacon receiver to configured the mobile device to receive the beacon signal is based at least in part on the indication of the timing in which the small cell base station will transmit a beacon signal.

18. The apparatus of claim 15, wherein the enhanced paging message includes an indication of the frequency in which the beacon signal will be transmitted, the beacon receiver to configure the mobile device to receive the beacon signal using the indicated frequency.

19. The apparatus of claim 15, wherein the mobile device is a first mobile device and wherein the enhanced paging message is intended for any one or both of a second mobile device and the small cell base station.

20. The apparatus of claim 15, further comprising an enhanced paging message responder executable by the circuitry to transmit a response to the enhanced paging message to the macro base station using a relay connection, the relay connection connecting the mobile device to the macro base station through the small cell base station.

21.-25. (canceled)
